(19) United States
(12) Patent Application Publication
(10) Pub. No.: US 2018/0094186 A1
(43) Pub. Date: Apr. 5, 2018

(54) METHOD OF HYDRAULIC FRACTURING USING FRACTURING FLUID MIXTURE WITH SHRINKABLE POLYMER FIBERS AND FINE PARTICLES

(71) Applicant: SCHLUMBERGER TECHNOLOGY CORPORATION, Sugar Land, TX (US)

(72) Inventors: Alexey Vladimirovich ALEKSEEV, Novosibirsk (RU); Konstantin Viktorovich VIDMA, Sugar Land, TX (US); Fedor Nikolaevich LITVINETS, Biysk (RU)

(21) Appl. No.: 15/563,744

(22) PCT Filed: Mar. 30, 2015
(86) PCT No.: PCT/RU2015/000196

§ 371 Date: Oct. 2, 2017

(51) Int. Cl. C09K 8/70; E21B 43/267; C09K 8/80

(52) U.S. Cl. CPC C09K 8/70; C09K 2208/08; C09K 8/80; E21B 43/267

(57) ABSTRACT

The disclosure relates to well systems for producing various fluids, in particular for producing the fluid from the hydrocarbon-bearing formation using hydraulic fracturing. According to the method of hydraulic fracturing of the formation intersected by the wellbore, the wellbore is provided, and the step of injecting the fracturing fluid without proppant to the wellbore is performed to form a fracture in the formation. Then, the step of injecting the fracturing fluid containing a mixture of fine particles and shrinkable polymer fibers is performed and the triggering mechanism is implemented, which causes the shrinkable polymer fibers to shrink, then the flowback of the fracturing fluid is provided and the fracture is cleaned. The provided method allows reducing the impact of the fracturing fluid flow on the proppant pillar geometry, as well as keeping the proppant in a consolidated state inside the agglomerates, pillars, or clogs, and preventing crushing of proppant pillars during the fracture closure.

### BACKGROUND

The present disclosure relates to hydrocarbon production stimulation using hydraulic fracturing of a formation.

In WO2014/042548 known in the art, a method of hydraulic fracturing using shapeable particles is provided. Fibers, ribbons, films, sheets, and flakes can be used as shapeable particles; these particles can also be shrinkable particles. The shapeable particles are injected into the well as a consolidating material for pillars to increase the heterogeneity of the proppant packing, which allows creating additional channels and increasing porosity, and, accordingly, permeability of the proppant packing.

In WO2013/095173 known in the art, a technique for using cement particles to create conductive fractures using a cement slurry is provided.

The main idea of this technique is to inject the cement slurry together with special additives into the well. In one embodiment, these additives are selected in order to provide cracking of the cement pack. In another embodiment, the additives are selected in order to provide agglomeration of the cement particles or to form heterogeneously distributed pillars. In both cases, after solidification, the created cement pack will form flow-conductive media with empty channels that provide conductive flow path for hydrocarbons from the formation to the well.

In U.S. Pat. No. 7,717,176, a permeable cement composition containing an aqueous slurry of hydraulic cement based on water-immiscible disperse fluid phase and hollow particles is provided. Consequently, compounding of these compositions reduces foaming. The volume of the foam represented 40% of the final volume of the foamed slurry, plus 15% of porosity after degradation of the hollow particles. This method allows the cement slurry to set at a temperature such that the hollow solid particles decompose when exposed to chemical and thermal environment in the cement, while leaving voids which, together with the disperse phase, result in a set cement having a permeability of at least 1 Darcy.

In U.S. Pat. No. 7,424,913 and WO2007/110591, a method, wherein the hydrated cement particles can be used by including them into the fracturing fluids as a proppant, is disclosed. In certain embodiments of the known solutions, after comminuting the hydrated mass into the hydrated cement particles, the hydrated cement particles can be coated with at least one additive. The coating of the admixture(s) onto the hydrated cement particles may be applied using any suitable coating method.

In the solutions known in the art, the main problem is to provide the ability to create a heterogeneous proppant pack, while no consideration is given to the problem of extending the service life of the well by reducing the effect of the flowback of the proppant-bearing fracturing fluid on the proppant pillars, as well as the problems of keeping the proppant in a consolidated state inside the agglomerates, pillars, clogs, etc., and preventing the proppant pillars from crushing during the fracture closure.

Accordingly, there is a need to provide a technique of extending the service life of the well by reducing the impact of fracturing fluid flow on the proppant pillars, as well as facilitating to keep the proppant in a consolidated state inside the agglomerates, pillars, clogs, etc., and preventing crushing of proppant pillars during the fracture closure.

### SUMMARY

The present description discloses a new approach to forming permeable channels, proppant consolidation in the pillars, and solidification of these pillars.

According to the claimed disclosure, the method of hydraulic fracturing of the formation intersected by the wellbore is disclosed. According to the claimed method, the wellbore is provided, and the step of injecting the fracturing fluid containing no proppant to the wellbore is performed to form a fracture in the formation. Then, the step of injecting the fracturing fluid comprising a mixture of fine particles and shrinkable polymer fibers is performed. A shrinkage triggering mechanism is described, which causes the shrinkable polymer fibers to shrink thus providing flowback of the fracturing fluid and the fracture clean-up.

### BRIEF DESCRIPTION OF DRAWINGS

Further, embodiments of the claimed disclosure are described in more details by means of drawings, wherein:

FIGS. 1A, 1B, and 1C show the steps of the embodiment of the disclosure;

FIG. 2A shows an illustration of the experimental cell containing the Fibers+Cement+Sand mixture after 30 minutes of heating at 80° C.;

FIG. 2B shows an illustration of the experimental cell containing the Fibers+Cement mixture after 30 minutes of heating at 80° C.; and

FIG. 3 shows an illustration of the used exemplary components concentration and the components ratio.

### DESCRIPTION OF EMBODIMENTS

Hydraulic fracturing is a widely used technique of hydrocarbon production stimulation. The essence of the technique is to inject the fracturing fluid (this could be represented by gelled oils, linear/cross-linked polymer solutions, water solutions, and acids) into the wellbore until the downhole pressure exceeds the fracture gradient of the rock. To maintain the fracture in an open state a proppant (proppant, such as sand or bauxite particles) is used. The efficiency of the hydraulic fracturing depends on the permeability of the fracture formed, which can be improved by forming a permeable channels in the proppant barrier. The following main objectives of the claimed disclosure are associated with these channels:
1. How to get the proppant particles together to form agglomerates (or clogs, pillars, etc.) and thus create the proppant pack heterogeneity inside the fracture?
2. How to keep the proppant in a consolidated state inside the agglomerates, pillars, clogs, etc., and to prevent squashing of the proppant pillars during the fracture closure?

Another common phenomenon challenging fracture permeability is proppant flowback. The proppant flowback typically occurs immediately during well clean-up operation or over a period of several days to weeks after the hydraulic fracturing of the formation, but it can also occur at any time during the life of the well. Due to the strong impact of the flowback resulting in the reduced production, damaging of equipment, dead downtime, and, ultimately, loss of revenue, another challenge is formulated:
3. How to prevent erosion of a proppant pillar by fluid flow?

The description discloses a new method of creating flow-permeable channels, proppant consolidation in pillars, and solidification of these pillars.

The main concept of the claimed disclosure involves adding fine-grained particles together with the shrinkable fibers to the fracturing slurry composition. During the hydraulic fracture, small particles can be transferred further, especially when low-viscosity fluids are used. At some point during the fracturing process, the fibers shrink (the shrinking process is triggered by the temperature, chemical environment, time of exposure, etc.), thereby gathering particles together and forming the agglomerates of particles, while leaving the space between the agglomerates with lower concentration of particles. Hence, the conductive channels are created in the fracture. Non-limiting example of a fine-grained material is cement. When cement is used, some additional benefits can be obtained due to material solidification within the fracture.

The novelty of the present disclosure is that the shrinkable polymer fibers and fine-grained particles (for example, cement) are added to the fracturing fluid in addition to the proppant. These particles can serve as the proppant, which, unlike the conventional proppant, is more likely to penetrate the fracture, because the smaller the particles, the lower their settling rate. In this wording, the fibers are responsible for the consolidation of the proppant and for the formation of the conductive channels in the proppant pack. Otherwise, the conductivity of such proppant pack would be low, which would, in turn, limits the hydrocarbon production from the well. In addition, the presence of the fibers reduces the crushing of these channels during the fracture closure and their erosion when exposed to the fluid flow.

In other words, the inventors propose to use the cement slurry as the fracturing fluid (with or without additional proppant, e.g., sand), which can also be used as the proppant after solidification. In order to increase the permeability of the proppant pack, the inventors suggest using shrinkable fibers, for example, bi-component/multicomponent fibers based on polylactic acid and polylactic acid (PLA/PLA), polylactic acid and polyglycolic acid (PLA/PGA), polylactic acid and polyvinyl alcohol (PLA/PVOH), and other degradable or non-degradable polymer or polymer mixture. These fibers consolidate the particles most effectively if the core and the sheath of such bi-component fiber are misaligned. Fiber shrinkage and cement solidification may occur before, during, or after the fracture closure.

In accordance with the embodiment of this disclosure, the heat-shrinkable fibers can be used as shrinkable fibers, as they change their dimensions along with the temperature changes, for example, the dimensions change when the temperature of polymer fibers increases due to subterranean heat.

In accordance with the embodiment of this disclosure, the diameter and the length of the shrinkable polymer fibers are within the range of 1 to 100 μm and 1 to 50 mm, respectively. It is difficult to pump thicker and longer fibers using currently available equipment.

These shrinkable fibers can be produced from any degradable and non-degradable polymers or copolymers as well as their combination, including all kinds of polyester polymers, polyolefins, polyamides, etc. The cross-section of these fibers can be of any shape, including circular, oval, trilobal-, star-shaped, and rectangular (ribbon-like fibers), etc.

In accordance with one embodiment, the non-degradable polymer fibers may be polyolefins, polyamides, polyesters, polyurethanes, polymethyl methacrylate, polystyrene, resins, their copolymers and/or combinations thereof.

In some embodiments, these fibers may be composed of one polymer or a mixture of two or more polymers or copolymers.

In some embodiments, these fibers may be bi-component. They may consist of a coaxially arranged sheath and a core, an eccentrically arranged sheath and a core, or any other configuration, wherein the core is made of one polymer, and the sheath is made of another polymer, copolymer, or with the same polymer having another length of the polymer chain or degree of crystallinity.

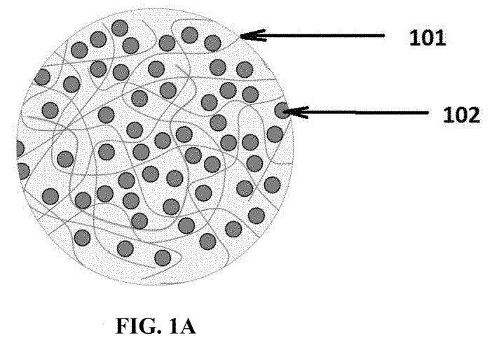

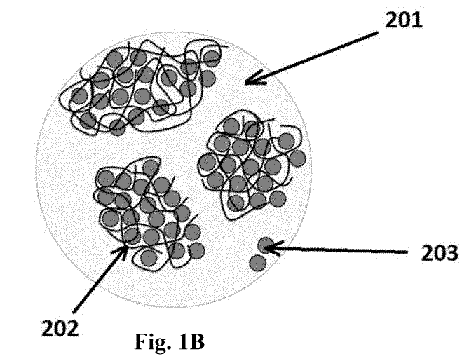

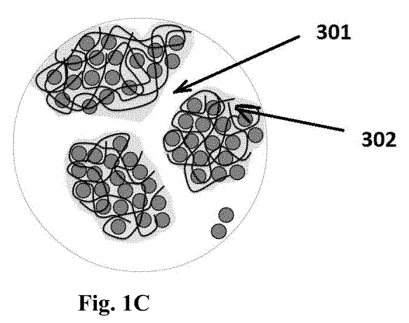

FIGS. 1A to 1C show the steps of the embodiment of the claimed method. According to the claimed method, after mixing the components (fluid and fine-grained solid particles and shrinkable fibers), the slurry should be placed into the fracture in a manner similar to the fibers in the FiberFRAC™ technology. This step of the method is shown in FIG. 1A, wherein 101 refers to the fibers, and 102 refers to the fine-grained particles. At a certain moment (for example, when the injection is stopped), the fibers will shrink under the effect of the triggering mechanism (for example, the temperature increase) and the proppant material located within the fiber network will consolidate in many separate clusters. This step of the method is shown in FIG. 1B, wherein 201 refers to the fracturing fluid, 202 refers to the fibers after shrinkage, and 203 refers to the settled proppant. Consequently, the proppant pack homogeneity would be disturbed, and the flow channels would be created up to the complete fracture closure. FIG. 1C shows the final step of the method, wherein, after the flowback of the fracturing fluid, when the fracturing fluid flows back to the wellbore, a system of proppant agglomerates and flow-permeable channels is formed, wherein 301 refers to the flow channels, and 302 refers to the agglomerate.

If cement is used as proppant material, then after cement solidification, the pillars are supposed to be extremely stable and hard (like a rock). It will considerably improve the erosion stability of the pillar. If cement sets before the fracture closure, then the crushing of the proppant agglomerates will be low.

If the viscosity of the fluid is sufficient for transporting the sand or conventional proppant material, then a portion of cement can be added to the sand mixture. The cement additive is used as a binding component, which is supposed to hold the proppant particles together after the formation of the proppant clots.

In order to verify the key assumptions, the disclosure was practically implemented using a specially designed model of a vertical fracture (analogy of the hydraulic fracturing of the formation). This model structure was made of two planar Plexiglas sheets fixed vertically and with a rubber seal between them. The distance between the walls was about 2 mm; the total volume of this slot-fracture was 200 mL. Three types of tests were conducted.

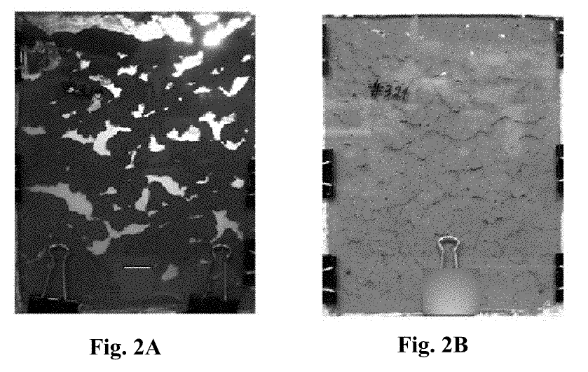

a) Fibers+Cement+Sand. A sample of 0.2428 g of bi-component shrinkable PLA/PLA fibers (the average fiber length is 6 mm, the diameter is 17 microns) was mixed with 120 g of sand (the mesh sizes are 50/140) and 120 g of cement in 200 mL of linear gel based on guar gum. For homogeneous distribution of the mixture components in the slot volume, this mixture was stirred for 2 minutes using an overhead mixer with the spindle rotating at 1,000 rpm. The slurry prepared in this way was placed into the fracture model and heated in an oven at the temperature of 80° C. for 30 minutes. As a result of heating, the formation of a system of channels filled with clean fluid and the accumulation of cement-bound sand were observed (FIG. 2A).

b) Fibers+Cement. The conditions of the experiment were similar to those described above except for the amount of sand (proppant). In this experiment, all sand was replaced with the same amount of cement, i.e., the total cement amount was 240.0 g per 200 mL of gel. The test results are shown in FIG. 2B. As can be seen, small cavities and channels formed in the cement-filled space, but in total, the cement distribution is more homogeneous than in the case shown in FIG. 2A.

c) Cement+Sand. After heating the cement-sand mixture in the oven up to 80° C., no channels was observed.

Based on the above experimental data, the conclusion was made that the presence of shrinkable fibers and the wide size distribution of particles achieved, for example, in 50/140 mesh size sand, contributed to heterogeneity in the cement-sand pack. The cement particles themselves are poorly captured by the fibers due to their small size (the size of the cement particles is from 5 to 10 μm, while size of the fibers is 17 μm). The fibers are more likely to capture relatively large particles, and they, in turn, entrain the cement particles.

A study was also conducted on the influence of the components concentration and their ratios on the efficiency of creating the heterogeneity in the cement pack.

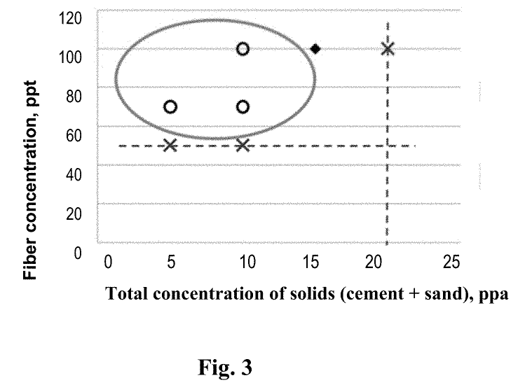

The concentrations of fibers and solid substance (sand and cement) were changed in this study. The procedure of the experiment is similar to described above in a); the results are shown in FIG. 3.

In FIG. 3, the concentration of fibers and the total concentration of solid particles (1:1 mixture of cement and sand) are shown as vertical and horizontal dashed lines (the plotting is in U.S. oilfield units) for a chosen set of cement, sand, and fiber. Under these conditions, the acceptable range of concentrations is shown within a depicted oval; in particular, the concentration of the shrinkable polymer fibers is within the range of 50-150 lb/1000 gal (6-18 g/L). However, this range does not limit the scope of our claims, because with other chosen proppant, cement, fluid, temperature, fibers, or fracture width, the range of acceptable concentrations can be expanded up to 10-500 lb/1000 gal (1.2-60 g/L). At lower fiber concentrations, the fibers cannot form a sufficiently dense fiber network to effectively consolidate the particles into clots/pillras. As a result, most particles are lost and settle down on the bottom of the fracture.

An increased concentration of the mixture of the proppant and fine-grained particles above 20 ppa (here “ppa” meaning “pounds of proppant added”) (2,400 g/L) is undesirable because the entire space of the fracture is filled with solid matter, leaving no space for channel formation.

It is apparent that the above embodiments shall not be regarded as a limitation of the scope of patent claims. It is clear for a person skilled in the art that it is possible to make many changes to the technique described above without departing from the principles of the disclosure claimed in the claims.

1. A method of hydraulic fracturing of a formation intersected by a wellbore, which comprises the following steps:
providing the wellbore;
performing a step of injecting a fracturing fluid without proppant into the wellbore to form a fracture in the formation;
performing a step of injecting the fracturing fluid comprising a mixture of fine particles and shrinkable polymer fibers into the well;
providing a triggering mechanism, which causes the shrinkable polymer fibers to shrink; and
providing a flowback of the fracturing fluid and cleaning of the fracture.

2. The method of claim 1, wherein the fine particles are cement.

3. The method of claim 1, wherein the proppant is further added at the step of injecting the fracturing fluid comprising a mixture of fine particles and shrinkable polymer fibers into the well.

4. The method of claim 3, wherein the proppant is sand.

5. The method of claim 1, wherein the concentration of the shrinkable polymer fibers is within the range of 10-500 lb/1000 gal (1.2-60 g/L).

6. The method of claim 3, wherein the total concentration of the mixture of the proppant and fine particles is less than 20 ppa (2,400 g/L).

7. The method of claim 1, wherein the diameter and the length of the shrinkable polymer fibers are within the range of 1 to 100 μm and 1 to 50 mm, respectively.

8. The method of claim 1, wherein the shrinkable polymer fibers are chosen from degradable and non-degradable polymers and combinations thereof, or degradable and non-degradable copolymers and combinations thereof.

9. The method of claim 8, wherein the shrinkable polymer fibers are selected from the group consisting of polyolefins, polyamides, polyesters, polyurethanes, polymethyl methacrylate, polystyrene, resins, their copolymers and/or combinations thereof.

10. The method of claim 8, wherein the cross-section shape of the shrinkable polymer fibers is selected from the group of shapes: circle, oval, trilobal, star, and rectangle.

11. The method of claim 1, wherein the shrinkable polymer fibers are bi-component or multicomponent.

12. The method of claim 11, wherein the shrinkable polymer fibers are composed of a coaxially arranged sheath and a core, or an eccentrically arranged sheath and a core, wherein the core is made of one polymer, and the sheath is made of another polymer, copolymer, or the same polymer having another length of the polymer chain or degree of crystallinity.

13. The method of claim 11, wherein the shrinkable polymer fibers are selected from the group consisting of polyolefins, polyamides, polyesters, polyurethanes, polymethyl methacrylate, polystyrene, resins, their copolymers and/or combinations thereof.

14. The method of claim 1, wherein the triggering mechanism is an increase in the temperature of polymer fibers due to subterranean heat.
